(19) United States
(12) Patent Application Publication
(10) Pub. No.: US 2016/0246145 A1
(43) Pub. Date: Aug. 25, 2016

(54) DETECTION CIRCUIT, LIQUID CRYSTAL DISPLAY PANEL AND METHOD FOR MANUFACTURING THE LIQUID CRYSTAL DISPLAY PANEL

(71) Applicant: Shenzhen China Star Optoelectronics Technology Co., Ltd., Shenzhen, Guangdong (CN)

(72) Inventors: Peng Du, Shenzhen, Guangdong (CN); Ming Hung Shih, Shenzhen, Guangdong (CN)

(73) Assignee: Shenzhen China Star Optoelectronics Technology Co., Ltd., Shenzhen, Guangdong (CN)

(21) Appl. No.: 14/417,695

(22) PCT Filed: Jan. 20, 2015
(86) PCT No.: PCT/CN2015/071063

§ 371 Date: May 6, 2016

(30) Foreign Application Priority Data
Oct. 21, 2014 (CN) 201410563955.8

(51) Int. Cl. G02F 1/1362; G02F 1/1335; G02F 1/1368

(52) U.S. Cl. CPC G02F 1/136286; G02F 1/1368; G02F 1/133514; G02F 2001/136254; G02F 2203/69

(57) ABSTRACT

Related to is a detection circuit, a liquid crystal display panel and a method for manufacturing the liquid crystal display panel. The detection circuit comprises a control switch unit, which is arranged between a test signal input terminal and a signal line of the liquid crystal display panel, and includes a first switch transistor and a second switch transistor connected in series. During test, the first switch transistor and the second switch transistor is kept on, so that a test signal is transmitted to the signal line of the liquid crystal display panel; after completion of the test, the second switch transistor is kept off, and a control terminal of the first switch transistor is in shorted connection with its first terminal, so as to reduce leakage current flowing into the signal line of the liquid crystal display panel through the second switch transistor. The liquid crystal display panel provided with this detection circuit can effectively reduce the risk of electric leakage without affecting its normal operation, thus ensuring the quality of the image display.

### CROSS-REFERENCE TO RELATED APPLICATIONS

The present disclosure claims benefit of Chinese patent application CN 201410563955.8, filed on Oct. 21, 2014, and entitled “DETECTION CIRCUIT, LIQUID CRYSTAL DISPLAY PANEL AND METHOD FOR MANUFACTURING THE LIQUID CIYSTAL DISPLAY PANEL,” the entire disclosure of which is hereby incorporated by reference.

### FIELD OF THE INVENTION

The present disclosure relates to a manufacturing process for a liquid crystal display panel, particularly to a detection circuit, and a liquid crystal display panel and method for manufacturing the liquid crystal display panel.

### BACKGROUND OF THE INVENTION

During the manufacture of a liquid crystal display panel (LCD Panel), a cell test is necessary to be applied onto a thin film transistor array substrate so as to checkout whether a thin film transistor on the array substrate for controlling a pixel unit is in a regular status. In this way, an abnormal array substrate may be sorted out, and such an undesirable product may be excluded rightly before subsequent manufacturing procedures. A detection circuit for the cell test is typically provided in a non-display area of the array substrate, and has two common wiring patterns, i.e., short ring layout and short bar layout. No matter the detection circuit is of a short ring layout or of a short bar layout, its electrical connection with a signal line of a display area on the array substrate has to be disconnected after the test, so as to prevent the detection circuit from affecting the regular operation of the liquid crystal display panel.

So far, there have been two commonly used cell test approaches. One is to connect data lines or gate lines on the array substrate in shorted connection together by means of several short rings or short bars, and then input a test signal to thin film transistors in pixel units of the array substrate via the short rings or shorting bars. After the test, a next step, such as assembling of a drive circuit module, may be performed only when the electrical connection between the short rings (or the short bars) and the data lines or the gate lines is cut off, e.g., by the laser. This method requires an additional step of laser cutting. However, laser cutting would produce many cutting particles and thereby degrades the LCD panel. As such, the other approach is more commonly applied now, i.e., adding a control switch between the short rings (or the short bars) and the scan lines or the data lines of the display area.

The control switch is kept on during the cell test, and is kept off after the completion of the test. As such, it is possible to omit the step of laser cutting, thereby achieving simplified manufacturing procedures and reduced costs.

However, in the second approach mentioned above, it is required to exert a high-level voltage onto a control terminal of the control switch during the test, and then a low-level voltage has to be applied thereto for a long term after the completion of the test. In the case that a thin film transistor is used as the control switch (as shown in FIG. 1), the gate of the thin film transistor is in a negative bias for a long term when the display panel is operating properly, in which case a voltage characteristic curve thereof (IV Curve) may be apt to drift. Meanwhile, since the testing short rings (or the short bars) are suspended for quite a long time, potentials thereon are susceptible to interference and thus have significant variations, such that a conductive channel between the drain and the source of the thin film transistor cannot be closed entirely and thus forms a leakage path. As a result, a leakage path (a dash line shown in FIG. 1) between different scan lines (or data lines) is formed by the detection circuit, and thereby leads to interference among signals of the different scan lines (or data lines), deteriorating the display effect of the panel. Therefore, how to improve the leakage among the internal signal lines while the normal operation is undisturbed has become an urgent technical problem to be solved.

### SUMMARY OF THE INVENTION

Aiming to the above problems, the present disclosure provides a detection circuit, a liquid crystal display panel and a method for manufacturing the liquid crystal display panel capable of alleviating electric leakage among signal lines inside the panel without any influences on its operation, so as to improving the image display quality.

The present disclosure provides a detection circuit for detecting a liquid crystal display panel having a plurality of signal lines, comprising: a test signal input terminal; and a control switch unit, arranged between the test signal input terminal and a signal line of the liquid crystal display panel, and including a first switch transistor and a second switch transistor connected in series, wherein during test, the first switch transistor and the second switch transistor are kept on, so that a test signal is transmitted to the signal line of the liquid crystal display panel; and after completion of the test, the second switch transistor is kept off, and a control terminal of the first switch transistor is in shorted connection with its first terminal, so as to reduce leakage current flowing into the signal line of the liquid crystal display panel through the second switch transistor.

According to an embodiment of the present disclosure, the first terminal of said first switch transistor is electrically connected to the test signal input terminal, and a second terminal thereof is electrically connected to a first terminal of the second switch transistor, a second terminal of which is electrically connected to the signal line of the liquid crystal display panel, and control terminals of the first switch transistor and the second switch transistor are electrically connected, respectively, to a first control signal input terminal and a second control signal input terminal. During test, the control terminals of the first switch transistor and the second switch transistor receive, respectively, high-level control signals through the first control signal input terminal and the second control signal input terminal, and are thereby turned on; and after completion of the test, the control terminal of the second switch transistor receives a low-level control signal through the second control signal input terminal and is thereby turned off.

According to an embodiment of the present disclosure, in the above detection circuit, after an array substrate is bonded with a color filter substrate, the control terminal of the first switch transistor and its first terminal may form a shorted connection therebetween by means of a wire arranged on the color filter substrate of the liquid crystal display panel.

In particular, said first switch transistor and said second switch transistor may be thin film transistors.

In addition, after completion of the test, the test signal input terminal is suspended, and a voltage thereof is a floating voltage.

According to an embodiment of the present disclosure, said signal line is a scan line or a data line on the array substrate of the liquid crystal display panel.

In another aspect, the present disclosure further provides a liquid crystal display panel including an array substrate, the array substrate comprising: a display area, provided with a plurality of pixel regions formed by a plurality of signal lines arranged in a staggered manner, wherein each pixel region is provided with a pixel unit including at least one thin film transistor, and the thin film transistor is electrically connected to the signal line and operates based on a voltage signal from the signal line; and a non-display area, provided with the above detection circuit for detecting the signal lines in the display area.

According to an embodiment of the present disclosure, the aforementioned liquid crystal display panel may further include a color filter substrate, on which a wire connecting, after the color filter substrate is bonded with the array substrate, a control terminal of a first control switch in said detection circuit in shorted connection with its first terminal is provided.

Finally, the present disclosure also provides a method for manufacturing a liquid crystal display panel, comprising the steps of: arranging, in a display area of the array substrate, a plurality of signal lines to form a plurality of pixel regions in a staggered manner, wherein each of the pixel regions is provided with a pixel unit including at least one thin film transistor, and wherein the thin film transistor is electrically connected to a signal line and operates based on a voltage signal from the signal line; providing, in a non-display area of the array substrate, the above mentioned detection circuit; and testing, by the detection circuit, the signal lines in the display area.

According to an embodiment of the present disclosure, said method for manufacturing a liquid crystal display panel further comprises the following step: after the completion of the test, the array substrate is bonded with the color filter substrate, and thus a control terminal of the first control switch in the detection circuit is in shorted connection with its first terminal by means of a wire arranged on the color filter substrate.

Compared with the prior art, the detection circuit and the resulted liquid crystal display panel provided by the present disclosure can effectively reduce the risk of electric leakage among the signal lines in the panel without affecting the normal operation, thus ensuring the quality of the image display. Other features and advantages of the present disclosure will be set forth in the following description, and part of them will be obvious from the description or be learned by practice of the disclosure.

### BRIEF DESCRIPTION OF THE DRAWINGS

FIG. 1 is a schematic structural view of a detection circuit in a liquid crystal display panel in the prior art;

FIG. 2 is a partial detail view of a detection circuit in a liquid crystal display panel according to an embodiment of the present disclosure;

FIG. 3 is an equivalent circuit of the detection circuit of FIG. 2 after an array substrate is bonded with a color filter substrate; and

FIG. 4 is a chart of current comparison of a second thin film transistor of the detection circuit according to an embodiment of the present disclosure against a thin film transistor of the detection circuit in the prior art under different gate voltages.

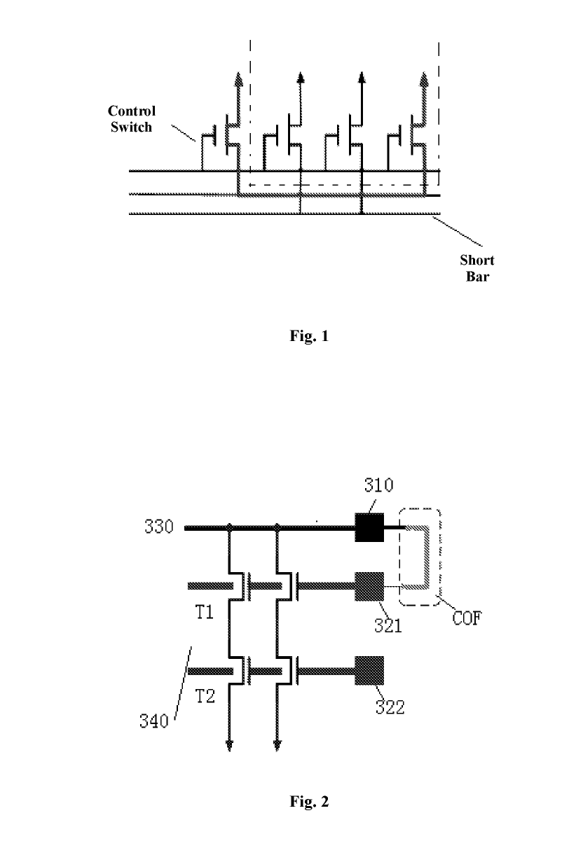

### DETAILED DESCRIPTION OF THE EMBODIMENTS

The present disclosure makes further improvements to a detection circuit of a liquid crystal display panel in the prior art, in order to eliminate electric leakage among signal lines inside the panel while its normal operation is unaffected. The technical solutions of the present disclosure and the achieved technical effects will be described in detail by reference to the drawings in combination with the following non-limiting embodiments.

In this embodiment, as is the same in the prior art, a liquid crystal display panel to be tested includes a thin film transistor (TTF) array substrate and a color filter substrate. In this case, the TTF array substrate is divided into two areas, i.e., a display area and a non-display area. The display area of the TTF array substrate includes a plurality of pixel regions formed by a plurality of scan lines and data lines in a staggered manner. Each of the pixel regions is provided with a pixel unit, and each of the pixel units includes at least one thin film transistor. Typically, the thin film transistor is electrically connected to a scan line via its gate, and to a data line via its source, and a drain of the thin film transistor is electrically connected to the pixel unit. In this way, under the action of a voltage signal of the scan line, a voltage signal of the data line is transmitted to the pixel electrode, such that the pixel electrode has a corresponding potential. The non-display area of the TTF array substrate is provided with a detection circuit for testing display-area signal lines and those thin film transistors.

In the present embodiment, the detection circuit adopts a short bar layout, and a control switch unit is provided in a circuit connection between a short bar (alternatively, a plurality of short bars) and each of the scan lines or of the data lines in the display area to control turn-on or off status of the circuit. Since the detection circuit uses completely a same process to detect the scan lines and the data lines, an approach for controlling on/off status of the circuit is exactly the same. Therefore, the configuration and detection process of the detection circuit will be described in detail below with signal lines being used thereafter to equally refer to the scan lines or the data lines.

FIG. 2 is a partial detail view of a detection circuit provided in an embodiment of the disclosure, which comprises: a test signal input terminal 310; a first control signal input terminal 321 and a second control signal input terminal 322; a short bar 330, electrically connected to the test signal input terminal 310 to receive a test signal; and a plurality of control switch units 340, wherein each of the control switch units 340 includes a first thin film transistor T1 and a second thin film transistor T2 in series connection with each other, the first thin film transistor T1 through its first terminal being electrically connected to the short bar, and through its second terminal to a first terminal of the second thin film transistor T2, a second terminal of the second thin film transistor T2 being electrically connected to a signal line (not shown in FIG. 2), and control terminals of the first thin film transistor T1 and the second thin film transistor T2 being electrically connected with the first control signal input terminal 321 and the second control signal input terminal 322 respectively.

In terms of the operating characteristics of the thin film transistor, said first terminal of either the first thin film transistor T1 or the second thin film transistor T2 may be a source or a drain, and said second terminal may be in turn a drain or a source, and the control terminal is a gate. In view of a principle of process simplification, in the above control switch units 340, the gates of all the first thin film transistors T1 may be electrically connected to the first control signal input terminal 321 via one wire, and the gates of all the second thin film transistors T2 may be electrically connected to the second control signal input terminal 322 through one wire.

Based on the above-mentioned connection pattern, during test of the liquid crystal display panel, a high-level voltage is applied to both the first control signal input terminal 321 and the second control signal input terminal 322 in a synchronous manner, such that the first thin film transistor T1 and the second thin film transistor T2 are both turned on, and thereby the entire control switch unit 340 is conducted. In this way, a test voltage at the short bar 330 in turn enters the signal line to be detected in the display area to test whether the array substrate operates abnormally.

As shown in FIG. 2, after the completion of the test of the liquid crystal display panel, it is a bonding process between the array substrate and the color filter (bonding). A preset wire on the color filter substrate can be used to easily enable short connection between the test signal input terminal 310 and the first control signal input terminal 321 in the detection circuit of the array substrate. That is, in each of the control switch units 340, the control terminal of the first thin film transistor T1 is in shorted connection with its first terminal. In this time, the first thin film transistor T1 in each of the control switch units 340 is similar to one diode disposed in forward direction between the short bar 330 and the first terminal of the second thin film transistor T2.

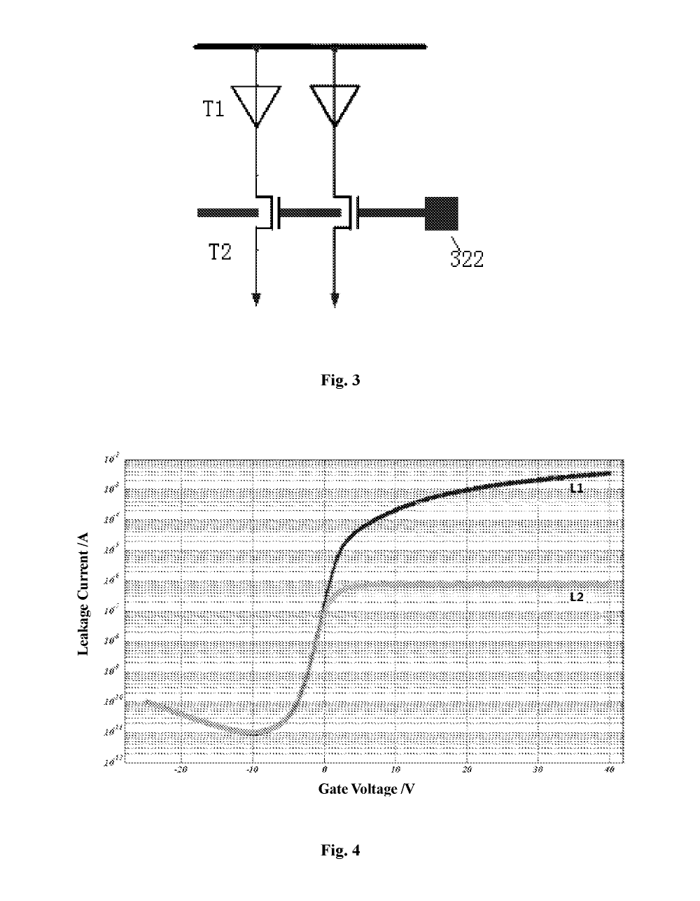

FIG. 3 is an equivalent circuit diagram of the detection circuit shown in FIG. 2 after the bonding of the array substrate and the color filter substrate. In this case, the operating principle of the second thin film transistor T2 is unchanged. Same as in the prior art, a low-level voltage is required to be continuously applied to the second thin film transistor T2 during the normal operation of the panel, such that the second thin film transistor T2 is turned off and thereby blocks the connection between the detection circuit and the display area of the array substrate, preventing the detection circuit from disturbing the normal operation of the liquid crystal display panel.

Meanwhile, it can be seen from FIG. 3 that there are two diodes in series-opposing connection with each other between any two signal lines on the array substrate, which can effectively reduce the leakage current between the signal lines, in particular, effectively alleviate adverse influences imposed on proper functioning of the liquid crystal display panel by the gate voltage variations of the second thin film transistor T2 or drift in operating characteristics of the second thin film transistor T2.

FIG. 4 is a chart simulated by SPICE software, showing current comparison of the second thin film transistor in the detection circuit of the present disclosure against a thin film transistor in a traditional detection circuit in terms of various gate voltages.

From illustrated comparison between different IV curves, it can be seen that, when a supplied control voltage (the gate voltage) is low, both the second thin film transistor in the detection circuit of the present disclosure and the thin film transistor in the conventional detection circuit can restrain the leakage current to a very narrow range. However, when the supplied control voltage (the gate voltage) increases, the leakage current of the second thin film transistor in the detection circuit of the present disclosure is lower than 10⁻⁶ A, while the leakage current of the thin film transistor in the conventional detection circuit has reached an order of magnitude of 10⁻³ A. There is a 1000 times difference between these two, which indicates that the liquid crystal display panel provided with the detection circuit of the present disclosure presents significant improvement in terms of leakage current control. In the figure, a curve labeled as L1 is the I-V curve of the thin film transistor in the conventional detection circuit, and a curve labeled as L2 is the I-V curve of the second thin film transistor in the detection circuit of the present disclosure, wherein I shows the leakage current, while V is the gate voltage.

Accordingly, the present disclosure further provides a liquid crystal display panel comprising an array substrate and a color filter substrate, wherein: a display area in the array substrate is provided with a plurality of pixel regions formed by a plurality of signal lines in a staggered manner, each of said pixel regions being provided with a pixel unit including at least one thin film transistor, wherein the thin film transistor is electrically connected to a signal line and operates based on a voltage signal from the signal line; a non-display area in the array substrate is provided with the detection circuit of the present disclosure; and the color filter substrate is further provided with a wire connecting, after the color filter substrate bonds with the array substrate, a control terminal of the first control switch in said detection circuit in shorted connection with its first terminal.

The present disclosure also provides a method for manufacturing the liquid crystal display panel, comprising the steps of: arranging, in the display area of the array substrate, a plurality of signal lines, to form a plurality of pixel regions in a staggered manner, wherein each of the pixel regions is provided with a pixel unit including at least one thin film transistor, and wherein the thin film transistor is electrically connected to a signal line and operates based on a voltage signal from the signal line; providing, in a non-display area of the array substrate, the detection circuit of the present disclosure; and testing, by the detection circuit, the signal lines in the display area.

Further, after the completion of the test, the array substrate is bonded with the color filter substrate, and thus a control terminal of the first control switch in the detection circuit is in shorted connection to its first terminal by means of a wire arranged on the color filter substrate.

Although the present disclosure has been set forth with reference to preferred embodiments, various modifications may be made thereto and parts thereof can be replaced with equivalents without departing from the scope of the present disclosure. For example, in the detection circuit, a wire for connecting a first thin film transistor with a test signal input terminal may be a short bar or a short ring. And, it is possible for one test signal to be connected to a set of signal lines, or alternatively, each of the test signals can be connected to a different signal line. Therefore, the present disclosure is not limited to the specific embodiments disclosed herein, but includes all technical solutions falling within the scope of the claims, and none of the equivalent alternations and modifications made on the basis of the technical solutions of the present disclosure should be ruled out of the scope of the present disclosure.

1. A detection circuit for detecting a liquid crystal display panel having a plurality of signal lines, comprising:
a test signal input terminal; and
a control switch unit, arranged between the test signal input terminal and a signal line of the liquid crystal display panel, and including a first switch transistor and a second switch transistor connected in series,
wherein during test, the first switch transistor and the second switch transistor are kept on, so that a test signal is transmitted to the signal line of the liquid crystal display panel; and after completion of the test, the second switch transistor is kept off, and a control terminal of the first switch transistor is in shorted connection with its first terminal, so as to reduce leakage current flowing into the signal line of the liquid crystal display panel through the second switch transistor.

2. A detection circuit of claim 1, wherein
the first terminal of said first switch transistor is electrically connected to the test signal input terminal, and a second terminal thereof is electrically connected to a first terminal of the second switch transistor, a second terminal of which is electrically connected to the signal line of the liquid crystal display panel, and control terminals of the first switch transistor and the second switch transistor are electrically connected, respectively, to a first control signal input terminal and a second control signal input terminal; and
during the test, the control terminals of the first switch transistor and the second switch transistor receive, respectively, high-level control signals through the first control signal input terminal and the second control signal input terminal, and are thereby turned on; and after completion of the test, the control terminal of the second switch transistor receives a low-level control signal through the second control signal input terminal and is thereby turned off.

3. A detection circuit of claim 1, wherein
after an array substrate is bonded with a color filter substrate, the control terminal of the first switch transistor and its first terminal form a shorted connection therebetween by means of a wire arranged on the color filter substrate.

4. A detection circuit of claim 2, wherein
after an array substrate is bonded with a color filter substrate, the control terminal of the first switch transistor and its first terminal form a shorted connection therebetween by means of a wire arranged on the color filter substrate.

5. A detection circuit of claim 1, wherein
the first switch transistor and said second switch transistor are thin film transistors.

6. A detection circuit of claim 1, wherein
the test signal input terminal is suspended after completion of test, and a voltage thereof is a floating voltage.

7. A detection circuit of claim 2, wherein
the test signal input terminal is suspended after completion of the test, and a voltage thereof is a floating voltage.

8. A detection circuit of claim 3, wherein
the signal line is a scan line or a data line on the array substrate of the liquid crystal display panel.

9. A detection circuit of claim 4, wherein
the test signal input terminal is suspended after completion of the test, and a voltage thereof is a floating voltage.

10. A liquid crystal display panel, comprising:
an array substrate, which comprises:
a display area, provided with a plurality of pixel regions formed by a plurality of signal lines arranged in a staggered manner, wherein each of the pixel regions is provided with a pixel unit including at least one thin film transistor, and the thin film transistor is electrically connected to the signal line and operates based on a voltage signal from the signal line; and
a non-display area, provided with a detection circuit for detecting the signal lines in the display area, wherein the detection circuit comprises:
a test signal input terminal; and
a control switch unit, arranged between the test signal input terminal and a signal line of the liquid crystal display panel, and including a first switch transistor and a second switch transistor connected in series, wherein during test, the first switch transistor and the second switch transistor are kept on, so that a test signal is transmitted to the signal line of the liquid crystal display panel; and after completion of the test, the second switch transistor is kept off, and a control terminal of the first switch transistor is in shorted connection with its first terminal, so as to reduce leakage current flowing into the signal line of the liquid crystal display panel through the second switch transistor.

11. A liquid crystal display panel of claim 10, wherein
the first terminal of said first switch transistor is electrically connected to the test signal input terminal, and a second terminal thereof is electrically connected to a first terminal of the second switch transistor, a second terminal of which is electrically connected to the signal line of the liquid crystal display panel, and control terminals of the first switch transistor and the second switch transistor are electrically connected, respectively, to a first control signal input terminal and a second control signal input terminal; and
during the test, the control terminals of the first switch transistor and the second switch transistor receive, respectively, high-level control signals through the first control signal input terminal and the second control signal input terminal, and are thereby turned on; and after completion of the test, the control terminal of the second switch transistor receives a low-level control signal through the second control signal input terminal and is thereby turned off.

12. A liquid crystal display panel of claim 10, further comprising:
a color filter substrate, on which a wire connecting, after the color filter substrate is bonded with the array substrate, a control terminal of a first control switch in said detection circuit in shorted connection with its first terminal is provided.

13. A liquid crystal display panel of claim 11, further comprising:
a color filter substrate, on which a wire connecting, after the color filter substrate is bonded with the array substrate, a control terminal of a first control switch in said detection circuit in shorted connection with its first terminal is provided.

14. A liquid crystal display panel of claim 10, wherein
the test signal input terminal is suspended after completion of the test, and a voltage thereof is a floating voltage.

15. A liquid crystal display panel of claim 11, wherein
the test signal input terminal is suspended after completion of the test, and a voltage thereof is a floating voltage.

16. A liquid crystal display panel of claim 12, wherein
the test signal input terminal is suspended after completion of the test, and a voltage thereof is a floating voltage.

17. A method for manufacturing a liquid crystal display panel, comprising the steps of:
arranging, in a display area of an array substrate, a plurality of signal lines to form a plurality of pixel regions in a staggered manner, wherein each of the pixel regions is provided with a pixel unit including at least one thin film transistor, and wherein the thin film transistor is electrically connected to a signal line and operates based on a voltage signal from the signal line;
providing, in a non-display area of the array substrate, a detection circuit; and
testing, by the detection circuit, the signal lines in the display area.

18. A method of claim 17, wherein
after the completion of test, the array substrate is bonded with a color filter substrate, and thus a control terminal of a first control switch in the detection circuit is in shorted connection with its first terminal by means of a wire arranged on the color filter substrate.
